(19) United States
(12) Patent Application Publication
(10) Pub. No.: US 2016/0227269 A1
(43) Pub. Date: Aug. 4, 2016

(54) DISPLAY APPARATUS AND CONTROL METHOD THEREOF

(71) Applicant: SAMSUNG ELECTRONICS CO., LTD., Suwon-si (KR)

(72) Inventor: Ji-youn HAN, Seoul (KR)

(73) Assignee: SAMSUNG ELECTRONICS CO., LTD., Suwon-si (KR)

(21) Appl. No.: 15/008,621

(22) Filed: Jan. 28, 2016

(30) Foreign Application Priority Data
Feb. 2, 2015 (KR) 10-2015-0016162

(51) Int. Cl. H04N 21/431; H04N 21/8545; G06F 3/0484; H04N 21/472; G06F 3/0482

(52) U.S. Cl. CPC H04N 21/4314; H04N 21/47205; G06F 3/0482; G06F 3/0484; H04N 21/8545

(57) ABSTRACT

A display apparatus is provided. The display apparatus includes: a display; a storage configured to store virtual content arrangements which include a first axis along which contents are classified into categories, and a second axis along which the contents belonging to each of the categories are arranged; a user interface configured to receive a user command on directions of the first axis and the second axis; and a processor configured to navigate to find content on the virtual content arrangements according to the user command, and, in response to a second content being selected by the content navigation while a first content is being reproduced, control the display to change the first content which is being reproduced to the second content and reproduce the second content. Accordingly, user's convenience is improved

### CROSS-REFERENCE TO RELATED APPLICATIONS

This application claims priority from Korean Patent Application No. 10-2015-0016162, filed on Feb. 2, 2015, in the Korean Intellectual Property Office, the disclosure of which is incorporated herein by reference in its entirety.

### BACKGROUND

1. Field

Apparatuses and methods consistent with exemplary embodiments relate to a display apparatus and a control method thereof, and more particularly, to a display apparatus which can reproduce a plurality of contents by a simple operation, and a control method thereof.

2. Description of the Related Art

Due to development of contents industry and electronic technology, various kinds of contents are being provided. In particular, broadcast contents are divided into various categories and also other kinds of contents such as web contents, etc. are created in recent years. Accordingly, there is difficulty in selecting a desired content from various contents.

FIG. 1A is a view showing an exemplary embodiment of a related-art method for changing a channel.

Referring to FIG. 1A, a user can change a channel simply through up and down buttons of a remote control device. However, as various kinds of contents are provided, many operations are required to select content as a user desires.

FIG. 1B is a view showing another exemplary embodiment of a related-art method for changing a channel.

Referring to FIG. 1B, a user may execute UI (user interface) screens through a menu button or a hub button as shown in the upper right view of FIG. 1B, and the UI screens may include a VOD service, a favorite menu, etc. When one of the UI screens is selected, UI screens may be displayed as shown in the lower right view of FIG. 1B, and the user may view a desired content by selecting one of the UI screens. However, the user should perform a complicated operation to view the content as the user desires, which may cause inconvenience.

### SUMMARY

Additional aspects and/or advantages will be set forth in part in the description which follows and, in part, will be apparent from the description, or may be learned by practice of embodiments.

Exemplary embodiments overcome the above disadvantages and other disadvantages not described above. Also, the embodiments are required to overcome the disadvantages described above, and an exemplary embodiment may not overcome any of the problems described above.

The embodiments provide a display apparatus which stores virtual content arrangements in which a plurality of contents are arranged, and controls to reproduce content which is selected by navigating on the arrangements according to a user command, and a control method thereof.

According to an aspect, a display apparatus includes: a display; a storage configured to store virtual content arrangements which include a first axis along which contents are classified into categories, and a second axis along which the contents belonging to each of the categories are arranged; a user interface configured to receive a user command on directions of the first axis and the second axis; and a processor configured to navigate to find content on the virtual content arrangements according to the user command, and, in response to a second content being selected by the content navigation while a first content is being reproduced, control the display to change the first content which is being reproduced to the second content and reproduce the second content.

In response to a predetermined user command being received while the first content is being reproduced, the processor may be configured to reduce an area on which the first content is reproduced, and control to display a plurality of contents arranged in the proximity of the first content on the virtual content arrangements on other areas of a screen.

In response to a predetermined user command being received while the first content is being reproduced, the processor may be configured to reduce the virtual content arrangements including the first content and display the virtual content arrangements in a form of a thumbnail list.

The processor may be configured to determine a number of contents included in the thumbnail list based on at least one of a resolution and a screen size of the display apparatus.

In response to the first content which is being reproduced being changed to the second content, the processor may be configured to change the virtual content arrangements such that contents related to the second content are arranged in the proximity of the second content from among the contents belonging to each of the categories.

The category may include a setting category including at least one function for controlling the display apparatus, and, in response to the first content which is being reproduced being changed to the second content, the processor may be configured to change the virtual content arrangements such that a frequently used function is arranged in the proximity of the second content from among functions belonging to the setting category.

The category may include at least one of a broadcast content category, a web content category, a favorite category, and a setting category.

The processor may be configured to display a UI screen which provides information on a plurality of categories for selecting a category of the first axis along which the contents are classified into the categories, and generate the virtual content arrangements by arranging the categories selected according to a user input on the UI screen in sequence.

The processor may be configured to generate the virtual content arrangements by dividing the categories in a horizontal axis direction and arranging the plurality of contents belonging to each of the categories in a vertical axis direction, and navigate in the horizontal axis direction and the vertical axis direction according to a four-direction user command to find content.

The user interface may be configured to receive the user command by means of one of a motion input, a pointing input, a voice input, a touch input, and a button input of a user.

According to another aspect, a control method of a display apparatus includes: receiving a user command on directions of a first axis and a second axis; according to the user command, navigating to find content on virtual content arrangements which include the first axis along which contents are classified into categories, and the second axis along which the contents belonging to each of the categories are arranged; and, in response to a second content being selected by the content navigation while a first content is being reproduced, changing the first content which is being reproduced to the second content and reproducing the second content.

The control method may further include, in response to a predetermined user command being received while the first content is being reproduced, reducing an area on which the first content is reproduced, and displaying a plurality of contents arranged in the proximity of the first content on the virtual content arrangements on other areas of a screen.

The control method may further include, in response to a predetermined user command being received while the first content is being reproduced, reducing the virtual content arrangements including the first content and displaying the virtual content arrangements in a form of a thumbnail list.

The displaying may include determining a number of contents included in the thumbnail list based on at least one of a resolution and a screen size of the display apparatus.

The control method may further include, in response to the first content which is being reproduced being changed to the second content, changing the virtual content arrangements such that contents related to the second content are arranged in the proximity of the second content from among the contents belonging to each of the categories.

The category may include a setting category including at least one function for controlling the display apparatus, and the control method may further include, in response to the first content which is being reproduced being changed to the second content, changing the virtual content arrangements such that a frequently used function is arranged in the proximity of the second content from among functions belonging to the setting category.

The category may include at least one of a broadcast content category, a web content category, a favorite category, and a setting category.

The control method may further include displaying a UI screen which provides information on a plurality of categories for selecting a category of the first axis along which the contents are classified into the categories, and generating the virtual content arrangements by arranging the categories selected according to a user input on the UI screen in sequence.

The navigating to find the content may include generating the virtual content arrangements by dividing the categories in a horizontal axis direction and arranging the plurality of contents belonging to each of the categories in a vertical axis direction, and navigating in the horizontal axis direction and the vertical axis direction according to a four-direction user command to find the content.

The receiving may include receiving the user command by means of one of a motion input, a pointing input, a voice input, a touch input, and a button input of a user.

According to another aspect a control method includes displaying a first content; receiving a user direction command indicating a direction on a first axis and a second axis, according to the user direction command, navigating to find content among virtual content arrangements which comprise the first axis along which contents are classified into categories, and the second axis along which the contents belonging to each of the categories are arranged, and in response to a second content being selected during content navigation based on the user direction command while the first content is being reproduced, replacing the first content with the second content and displaying the second content.

According to the various exemplary embodiments as described above, the display apparatus can reproduce content which is selected by navigating on the arrangements according to a user command, and thus can provide users with convenience in manipulating.

Additional and/or other aspects and advantages of the embodiments will be set forth in part in the description which follows and, in part, will be obvious from the description, or may be learned by practice of the embodiments.

### BRIEF DESCRIPTION OF THE DRAWING FIGURES

The above and/or other aspects of the embodiments invention will be more apparent by describing certain exemplary embodiments with reference to the accompanying drawings, in which:

FIGS. 1A and 1B are views showing various exemplary embodiments of a related-art method for changing a channel;

FIGS. 2A and 2B are block diagrams showing a configuration of a display apparatus according to an exemplary embodiment;

FIG. 3 is a view showing virtual content arrangements according to an exemplary embodiment;

FIG. 4 is a view to illustrate a screen on which content is changed according to an exemplary embodiment;

FIG. 5 is a view to illustrate display of a thumbnail list according to an exemplary embodiment;

FIGS. 6A to 6C are views to illustrate change of virtual content arrangements according to various exemplary embodiments;

FIG. 7 is a view to illustrate change of arrangements of a setting category according to an exemplary embodiment;

FIG. 8 is a view to illustrate generation of virtual content arrangements according to an exemplary embodiment; and

FIG. 9 is a flowchart illustrating a control method of a display apparatus according to an exemplary embodiment.

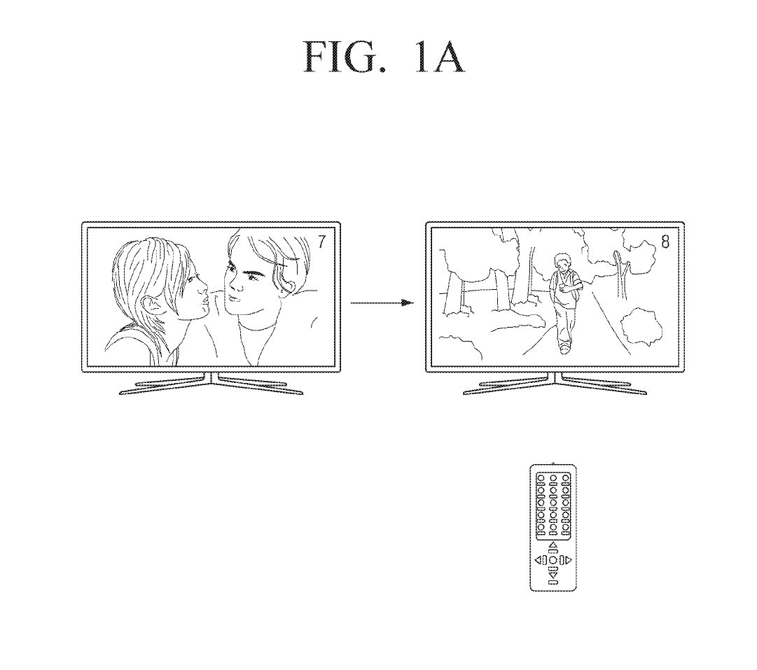

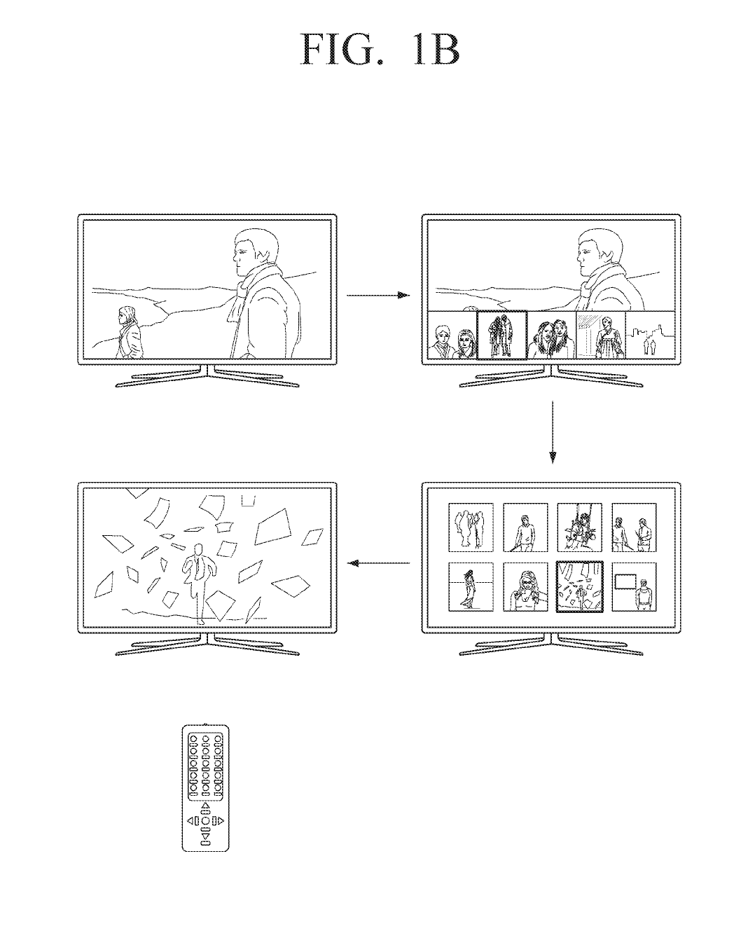

### DETAILED DESCRIPTION

Reference will now be made in detail to the embodiments, examples of which are illustrated in the accompanying drawings, wherein like reference numerals refer to the like elements throughout. The embodiments are described below to explain by referring to the figures.

The exemplary embodiments of the present disclosure may be diversely modified. Accordingly, specific exemplary embodiments are illustrated in the drawings and are described in detail in the detailed description. However, it is to be understood that the present disclosure is not limited to a specific exemplary embodiment, but includes all modifications, equivalents, and substitutions without departing from the scope and spirit of the present disclosure. Also, well-known functions or constructions are not described in detail since they would obscure the disclosure with unnecessary detail.

Exemplary embodiments will now be described in greater detail with reference to the accompanying drawings.

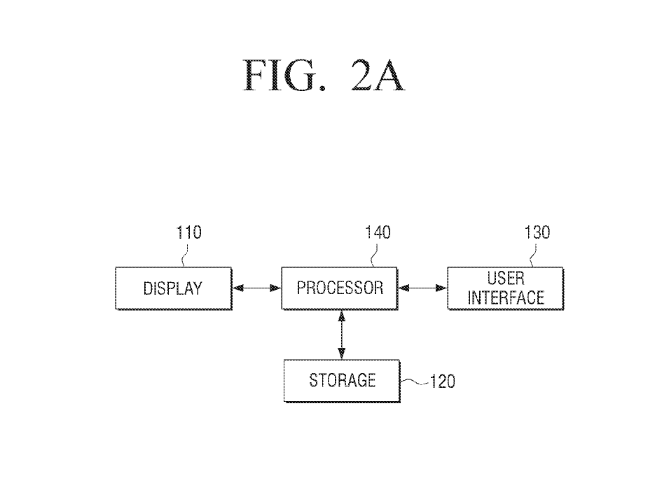

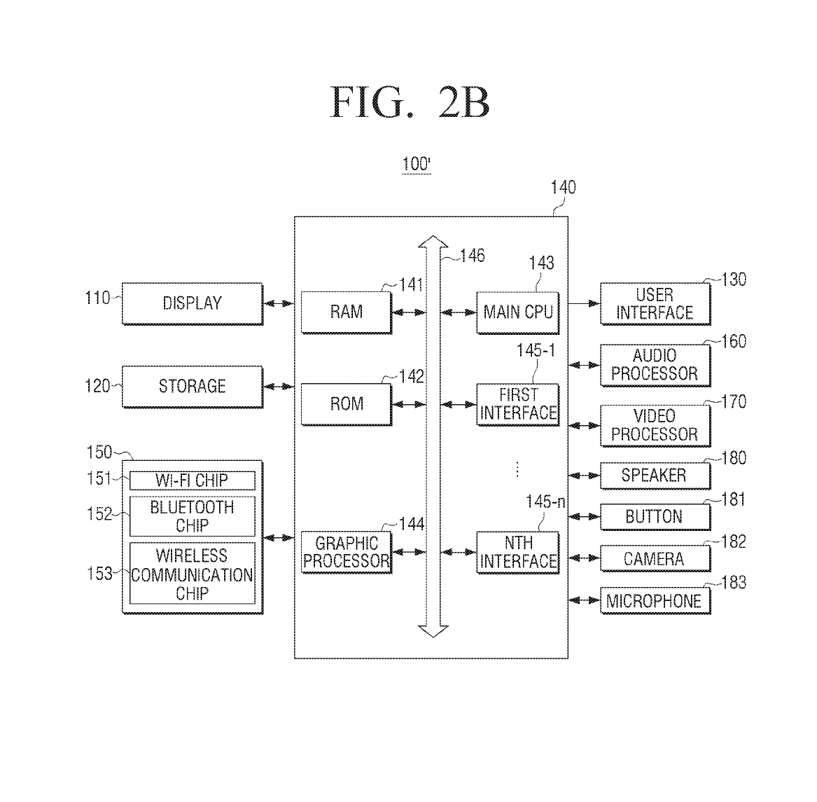

FIGS. 2A and 2B are block diagrams showing a configuration of a display apparatus 100 according to an exemplary embodiment.

Referring to FIG. 2A, the display apparatus 100 includes a display 110, a storage 120, a user interface 130, and a processor 140.

FIG. 2A illustrates overall elements of the display apparatus 100 when the display apparatus 100 is equipped with various functions such as a display function, a storing function, etc., for example. Accordingly, some of the elements illustrated in FIG. 2A may be omitted or changed, and other elements may be added according to an exemplary embodiment.

The display 110 displays a selected content under the control of the processor 140. In particular, in response to a displayed content being changed, the display 110 may display the changing process through an animation effect, etc. For example, the display 110 may display the screen of a displayed content to be moved to the left and display the screen of content to be displayed to be moved from the right to the left. A detailed description thereof will be provided hereinbelow.

In addition, the display 110 may be implemented by using a Liquid Crystal Display (LCD) panel, Organic Light Emitting Diodes (OLEDs), etc. However, this should not be considered as limiting. In addition, the display 110 may be implemented by using a flexible display, a transparent display, etc. according to circumstances.

The storage 120 may store virtual content arrangements including a first axis along which contents are classified into categories, and a second axis along which the contents belonging to each of the categories are arranged. For example, the categories may include a broadcast content category, a web content category, a favorite category, and a setting category. However, this should not be considered as limiting. The storage 120 may further include an external device category and a social content category.

In addition, the storage 120 may subdivide each of the content categories in more detail, and store the categories. For example, the storage 120 may divide the broadcast content category into a domestic broadcast content category and an abroad broadcast content category, and store the domestic broadcast content category and the abroad broadcast content category instead of the broadcast content category.

In addition, the storage 120 may store the virtual content arrangements including the first axis and the second axis. However, this should not be considered as limiting. For example, the storage 120 may store virtual content arrangements including a first axis, a second axis, and a third axis.

The user interface 130 may receive a user command on a first axis direction and a second axis direction. For example, the first axis may be in a horizontal axis direction and the second axis may be in a vertical axis direction. In addition, when the storage 120 stores virtual content arrangements including a first axis, a second axis, and a third axis, the user interface 130 may receive a user command on first axis, second axis and third axis directions.

The user interface 130 may receive the user command by means of one of a motion input, a pointing input, a voice input, a touch input, and a button input of a user. For example, the user interface 130 may receive the user command by receiving a touch input on the surface of the display 110 or through a button provided on the display apparatus 100.

The processor 140 (or computer) may control the overall operations of the display apparatus 100.

The processor 140 may navigate to find content on the virtual content arrangements according to a user command, and, in response to a second content being selected by the content navigation while a first content is being reproduced, the processor 140 may control the display 110 to change the first content which is being reproduced to the second content and reproduce the second content.

In addition, in response to a predetermined user command being received while the first content is being reproduced, the processor 140 may reduce the area where the first content is being reproduced, and display a plurality of contents arranged in the proximity of the first content on the virtual content arrangements on the other areas of the screen.

In addition, in response to a predetermined user command being received while the first content is being reproduced, the processor 140 may reduce the virtual content arrangements to include as many contents as a predetermined number with reference to the first content, and display the virtual content arrangements.

In addition, the processor 140 may determine the predetermined number based on at least one of a resolution and a screen size of the display apparatus 100.

In addition, in response to the first content which is being reproduced being changed to the second content, the processor 140 may change the virtual content arrangements such that contents related to the second content are arranged in the proximity of the second content from among the contents belonging to each of the categories.

In addition, the categories may include the setting category including at least one function for controlling the display apparatus 100, and, in response to the first content which is being reproduced being changed to the second content, the processor 140 may change the virtual content arrangements such that a frequently used function is arranged in the proximity of the second content from among the functions belonging to the setting category.

In addition, the categories may include at least one of the broadcast content category, the web content category, the favorite category, and the setting category.

In addition, the processor 140 may display a UI screen for providing a plurality of categories in order for the user to select a category of the first axis, and may generate the virtual content arrangements by arranging the categories selected according to a user input in sequence.

In addition, the processor 140 may generate the virtual content arrangements by dividing the categories in the horizontal axis direction and arranging the plurality of contents belonging to each of the categories in the vertical axis direction, and may navigate in the horizontal axis direction and the vertical axis direction according to a four-direction user command to find content.

In addition, the user interface 130 may receive a user command by means of one of a motion input, a pointing input, a voice input, a touch input, and a button input of the user.

FIG. 2B is a block diagram showing a detailed configuration of a display apparatus 100′ according to another exemplary embodiment. Referring to FIG. 2B, the display apparatus 100′ includes a display 110, a storage 120, a user interface 130, a processor 140, a communicator 150, an audio processor 160, a video processor 170, a speaker 180, a button 181, a camera 182, and a microphone 183. The same elements as in FIG. 2A from among the elements shown in FIG. 2B will not be described in detail.

The processor 140 may control the overall operations of the display apparatus 100′ using various programs stored in the storage 120.

Specifically, the processor 140 may include a Random Access Memory (RAM) 141, a Read Only Memory (ROM) 142, a main Central Processing Unit (CPU) 143, a graphic processor 144, first to n-th interfaces 145-1 to 145-n, and a bus 146.

The RAM 141, the ROM 142, the main CPU 143, the graphic processor 144, and the first to n-th interfaces 145-1 to 145-n may be connected with one another via the bus 146.

The first to n-th interfaces 145-1 to 145-n may be connected with the above-described various elements. One of the interfaces may be a network interface which is connected with an external device via a network.

The main CPU 143 may access the storage 120 and perform booting using an operating system (O/S) stored in the storage 120. In addition, the main CPU 143 may perform various operations using various programs stored in the storage 120.

The ROM 142 may store a set of instructions for booting a system. In response to a turn on command being inputted and power being supplied, the main CPU 143 may copy the O/S stored in the storage 120 into the RAM 141 according to a command stored in the ROM 142, and boot the system by executing the O/S. In response to the booting being completed, the main CPU 143 may copy various application programs stored in the storage 120 into the RAM 141, and perform various operations by executing the application programs copied into the RAM 141.

The graphic processor 144 may generate a screen including various objects such as an icon, an image, a text, etc., using a calculator (not shown) and a renderer (not shown). The calculator (not shown) may calculate attribute values of objects to be displayed according to a layout of the screen, such as a coordinate value, a shape, a size, a color, etc., based on a received control command. The renderer (not shown) may generate the screen of various layouts including objects based on the attribute values calculated by the calculator (not shown). The screen generated by the renderer (not shown) may be displayed in a display area of the display 110.

The above-described operations of the processor 140 may be achieved by a program stored in the storage 120.

The storage 120 may store a variety of data such as an O/S software module for driving the display apparatus 100′, virtual content arrangements, a variety of GUI information, etc.

In this case, the processor 140 may reproduce content or display arrangements of a plurality of contents based on the information stored in the storage 120.

The user interface 130 may receive various user interactions. The user interface 130 may be implemented in various forms according to an implementation example of the display apparatus 100′. When the display apparatus 100′ is implemented by using a digital TV, the user interface 130 may be implemented by using a remote control receiver for receiving a remote control signal from a remote control device, a camera for sensing a user motion, a microphone for receiving a user voice, etc. In addition, when the display apparatus 100′ is implemented by using a touch-based portable terminal, the user interface 130 may be implemented in the form of a touch screen forming a mutual layer structure with a touch pad. In this case, the user interface 130 may be used as the above-described display 110.

The communicator 150 may communicate with a remote control device or a server.

Specifically, the communicator 150 may receive signals from the remote control device. In addition, the communicator 150 may receive content and additional information on the content from the server.

The communicator 150 may perform unidirectional communication or bidirectional communication with the remote control device or the server. When the communicator 150 performs the unidirectional communication, the communicator 150 may receive signals from the remote control device or the server. When the communicator 150 performs the bidirectional communication, the communicator 150 may receive signals from the remote control device or the server or transmit signals to the remote control device or the server.

A sensor (not shown) may include a touch sensor, a gyro sensor, a proximity sensor, etc. The sensor may detect various operations such as pressing, approaching, etc. in addition to the above-described touch.

The touch sensor may be implemented by using a capacitive type or a resistive type of sensor. The capacitive type calculates touch coordinates by detecting minute electricity excited in a user's body when a part of the user's body touches the surface of the display, using a dielectric substance coated on the surface of the display. The resistive type includes two electrode plates embedded in the display apparatus 100′, and, when the user touches the screen, calculates touch coordinates by detecting an electric current flowing due to contact between upper and lower plates at the touched point. In addition, infrared beam, surface acoustic wave, integral strain gauge, piezo electric, etc. may be used to detect a touch interaction.

In addition, the display apparatus 100′ may determine whether a touch object such as a finger or a stylus pen touches or approaches using a magnetic field sensor, an optical sensor, a proximity sensor, etc. instead of the touch sensor.

The proximity sensor senses a motion which approaches without directly contacting the display surface. The proximity sensor may be implemented by using various types of sensors such as a high-frequency oscillation type proximity sensor which forms a high frequency magnetic field and detects an electric current induced by a magnetic characteristic which is changed when an object approaches, a magnetic type proximity sensor which uses a magnet, and a capacitive type proximity sensor which detects capacitance that changes when an object approaches, etc.

The audio processor 160 is an element for processing audio data. The audio processor 160 may perform various processing operations such as decoding, amplification, noise filtering, etc. with respect to the audio data.

The video processor 170 is an element for processing video data. The video processor 170 may perform various image processing operations such as decoding, scaling, noise filtering, frame rate conversion, resolution conversion, etc. with respect to the video data.

The speaker 180 is an element for outputting not only various audio data processed by the audio processor 160 but also various notification sounds, voice messages, etc.

The button 181 may include various types of buttons such as a mechanical button, a touch pad 210, a wheel, etc. formed on a certain area of the display apparatus 100′, such as a front surface, a side surface, and a rear surface of the body exterior of the display apparatus 100′.

The camera 182 is an element for photographing a still image or a moving image under the control of the user. The camera 182 may include a plurality of cameras such as a front surface camera and a rear surface camera. The microphone 183 is an element for receiving an input of a user voice or other sounds and converting the user voice or sound into audio data.

Hereinafter, the basic configuration and various exemplary embodiments will be explained for easy understanding of the present disclosure.

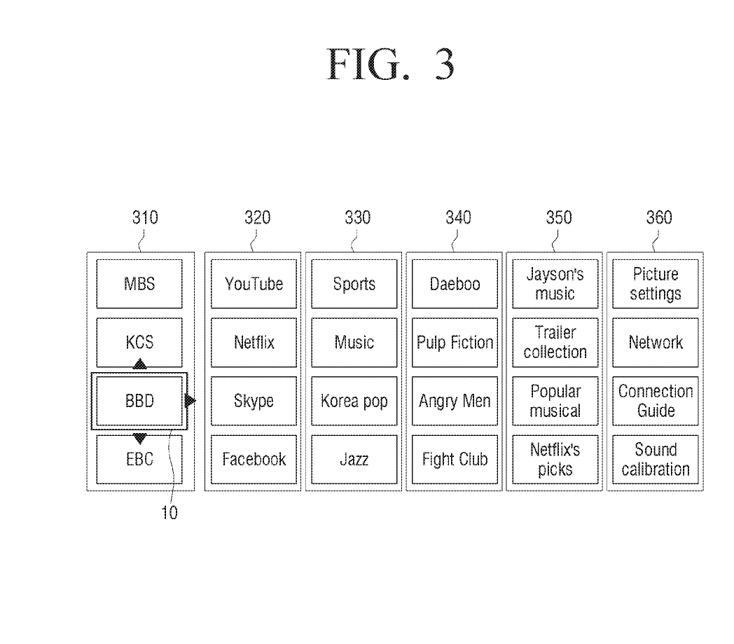

FIG. 3 is a view showing virtual content arrangements according to an exemplary embodiment.

Referring to FIG. 3, the virtual content arrangements may include a first axis along which contents are classified into categories, and a second axis along which the contents belonging to each of the categories are arranged. However, this should not be considered as limiting, and the virtual content arrangements may include a single axis or one or more axes.

The category may include at least one of a broadcast content category 310, a web content category 320, 350, a favorite category 340, 350, and a setting category 360. The web content category 320, 330 may be divided into a social content category 320 and a YouTube content category 330. However, this should not be considered as limiting, and the category may be divided into more various categories.

In addition, the favorite category 340, 350 may be divided into a favorite menu category 350 and a favorite movie category 340. However, this should not be considered as limiting, and the category may be divided into more various categories such as a favorite drama category, a favorite music category, etc.

The broadcast content category 310 may classify broadcast contents provided by broadcast providers and provide the broadcast contents, the social content category 320 may provide social media applications, and the YouTube content category 330 may classify moving images provided by YouTube into sport, music, KPOP, etc. and provide the moving images.

The favorite content category 340, 350 may include contents which are set to be included in the favorite category by the user. The setting category 360 may provide setting menus, etc. to change the settings of the display apparatus 100′.

The processor 140 may navigate to find content on the virtual content arrangements according to a user command, and, in response to a second content being selected by the content navigation while a first content is being reproduced, the processor 140 may change the first content which is being reproduced to the second content and reproduce the second content. Referring to FIG. 3, the processor 140 is reproducing a broadcast channel BBD. In this state, the processor 140 may receive a user command. In response to the user command being a direction key input in the right direction, the processor 140 may display Skype which is located on the right side of the broadcast channel BBD on the virtual content arrangements.

In this case, the processor 140 may not display the virtual content arrangements and a virtual selection GUI 10 for content navigation, and may directly change the content and reproduce the content. However, this should not be considered as limiting. The processor 140 may display the virtual content arrangements and the virtual selection GUI, and may display a screen on which the selection GUI is moved on the content arrangements according to a user input. A detailed description regarding this will be provided below.

The processor 140 may generate the virtual content arrangements by dividing the categories in the horizontal axis direction and arranging the plurality of contents belonging to each of the categories in the vertical axis direction. However, this should not be considered as limiting, and the processor 140 may generate the virtual content arrangements by reversing the horizontal axis direction and the vertical axis direction.

The processor 140 may arrange the contents belonging to each of the categories in the order of update. However, this is merely an example. The contents may be arranged in the order of creation or in alphabetical order.

The processor 140 may navigate to find content in the horizontal axis direction and the vertical axis direction according to a four-direction user command. In FIG. 3, the virtual selection GUI 10 for content navigation is illustrated, and the virtual selection GUI 10 is in the form of a focus. However, this should not be considered as limiting. For example, the selection GUI 10 may be in the form of a mouse. In addition, the user command is not limited to the four-direction user command. For example, diagonal directions may be added in addition to the four horizontal and vertical directions, and thus a user command may be inputted in eight directions.

In FIG. 3, the virtual selection GUI 10 indicates the broadcast channel BBD and is displayed as being movable upwardly and downwardly and to the right. However, this should not be considered as limiting. In response to a command to move to the left being inputted, the virtual selection GUI 10 may be moved to the opposite side on the virtual content arrangements. For example, in FIG. 3, the virtual selection GUI 10 may be located on Connection Guide in response to the command to move to the left being inputted.

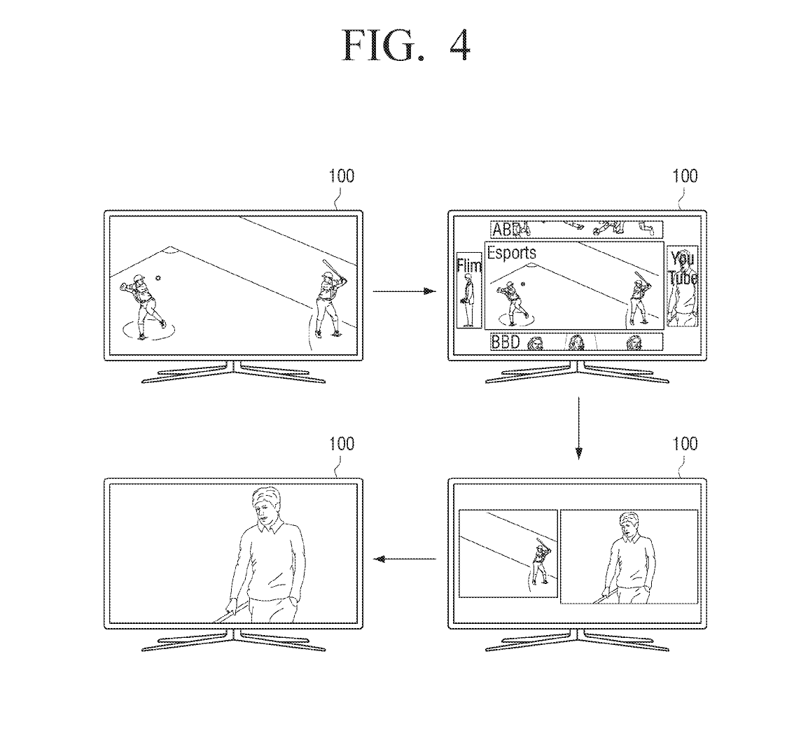

FIG. 4 is a view to illustrate a screen on which content is changed according to an exemplary embodiment.

Referring to FIG. 4, the processor 140 may receive a predetermined user command while a first content is being reproduced. For example, the processor 140 may display the first content on the entire display 110, and receive a menu entering command, a specific service entering command, and an external device connecting command as the predetermined user command. In addition, the predetermined user command may be a four-direction user command.

In response to the predetermined user command being received, the processor 140 may reduce the area on which the first content is reproduced, and display a plurality of contents arranged in the proximity of the first content on the virtual content arrangements on the other areas of the screen. For example, referring to FIG. 4, in response to the predetermined user command being received while content related to a sport is being displayed, the processor 140 may reduce the screen on which the sport-related content is reproduced, and display contents ABD, Film, BBD, YouTube located on the top, bottom, left, and right of the sport-related content on the virtual content arrangements.

In this case, the processor 140 may display a part or entirety of the content reproduction screen according to the size of the reproduction area of the neighboring content. Alternatively, the processor 140 may reduce the size of the neighboring content according to a reproduction area and display the content. For example, referring to the upper right view of FIG. 4, a part of the neighboring content is displayed since the reproduction area of the content is small. However, the processor 140 may reduce the reproduction area of the first content and display the first content, and accordingly, the processor 140 may magnify the reproduction area of the neighboring content and display the content.

In the upper right view of FIG. 4, four neighboring contents are illustrated. However, this should not be considered as limiting. For example, all of the contents located along the diagonal line from the location of the first content on the virtual content arrangements may be displayed. In this case, the processor 140 may display eight neighboring contents on the periphery of the first content.

In response to a specific user input in the state shown in the upper right view of FIG. 4, the processor 140 may display a screen on which the content is changed as shown in the lower right view of FIG. 4, and reproduce the new content as shown in the lower left view of FIG. 4. In this case, the specific user input may be a user command corresponding to one of the four directions.

The user command may be a remote input by a remote control device. The remote control device may be provided with a button or a touch pad. In addition, the user command may be generated by the user touching the display 110 or the display apparatus 100 detecting a user's operation.

In response to a user command on one of the four directions being inputted, the processor 140 may display the screen on which the first content is changed to the second content. However, this should not be considered as limiting. The processor 140 may not display the screen showing the change and directly display the second content.

In addition, in FIG. 4, in the method for changing the content, the reproduction screen of the first content is moved to the left while being reduced and the reproduction screen of the second content is moved to the left while being magnified. However, this should not be considered as limiting. For example, the first content and the second content may be moved to the left without changing the size of the reproduction screen, or the second content may be moved to the left while the first content is being reproduced and may overlap the first content.

In FIG. 4, the processor 140 reproduces the neighboring contents. However, this is merely an example. For example, the neighboring contents may not be reproduced and only the categories and the content names of the neighboring contents may be displayed.

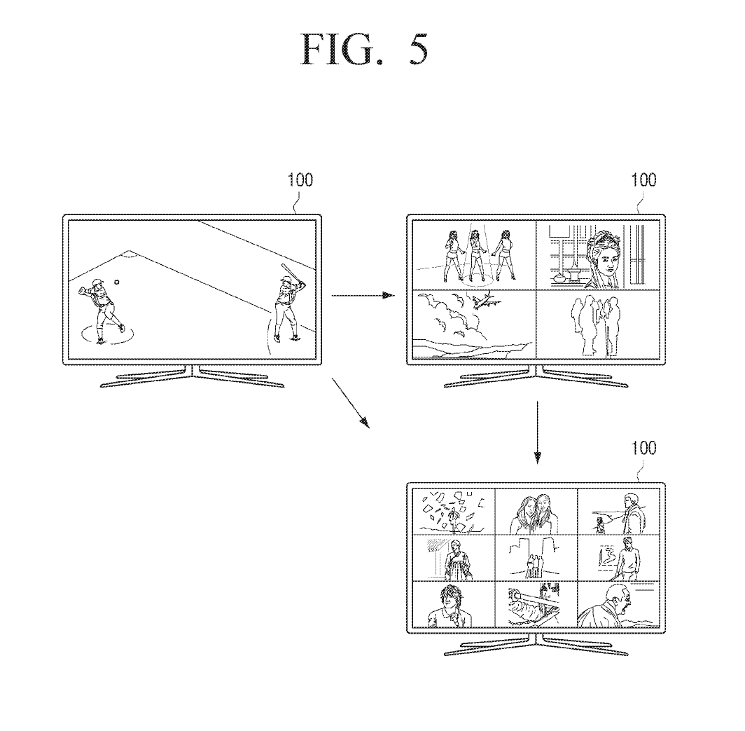

FIG. 5 is a view to illustrate display of a thumbnail list according to an exemplary embodiment.

Referring to FIG. 5, in response to a predetermined user command being received while a first content is being reproduced, the processor 140 may reduce the virtual content arrangements including the first content and display the virtual content arrangements in the form of a thumbnail list. The predetermined user command may be a hub entering command, a specific service entering command, etc.

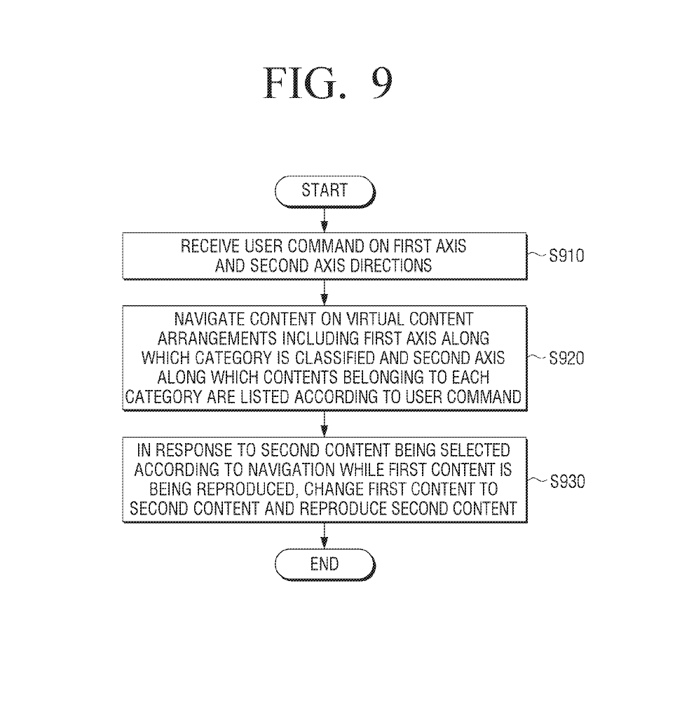

In response to the predetermined user command being inputted, the processor 140 may display four contents as shown in the upper right view of FIG. 5. In response to a predetermined user command being inputted once more, the processor 140 may display nine contents as shown in the lower right view of FIG. 5. However, this is merely an example, and, in response to a predetermined user command being inputted, the processor 140 may directly change the screen shown in the left view to the screen on which the nine contents are displayed as shown in the lower right view of FIG. 9.

The processor 140 displays the thumbnail list according to the predetermined user command. However, this should not be considered as limiting. For example, the processor 140 may display a screen on which each of the plurality of contents is reproduced, or may reproduce only the content which has been displayed before the predetermined user command is inputted and display the other contents in the form of a thumbnail.

In addition, the processor 140 may determine the number of contents included in the thumbnail list based on at least one of a resolution and a screen size of the display apparatus 100. For example, when the resolution of the display apparatus 100 is low, only the four contents may be displayed, and, when the resolution of the display apparatus 100 is high, the nine contents may be displayed. In addition, the same method may be applied to the screen size of the display apparatus 100.

Referring to FIG. 5, the content which has been displayed before the predetermined user command is inputted is located on the upper left side of the thumbnail list in response to the predetermined user command. However, this is merely an example and the content which has been displayed may be located on the upper right side or the center of the screen.

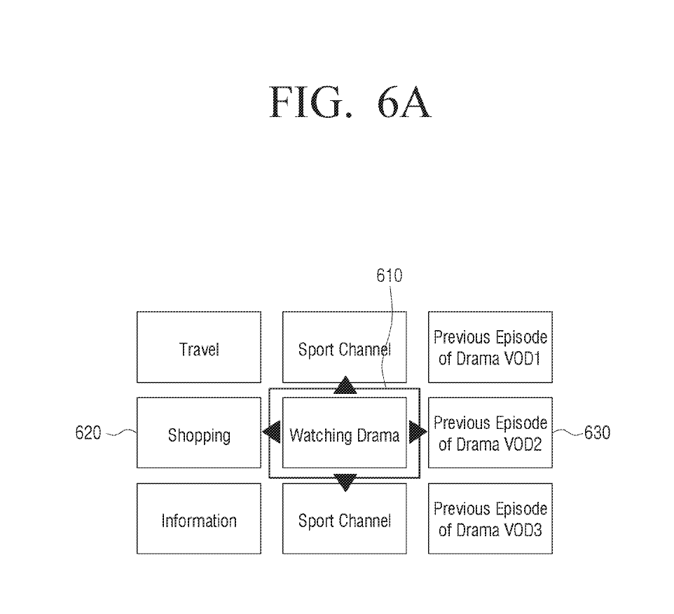

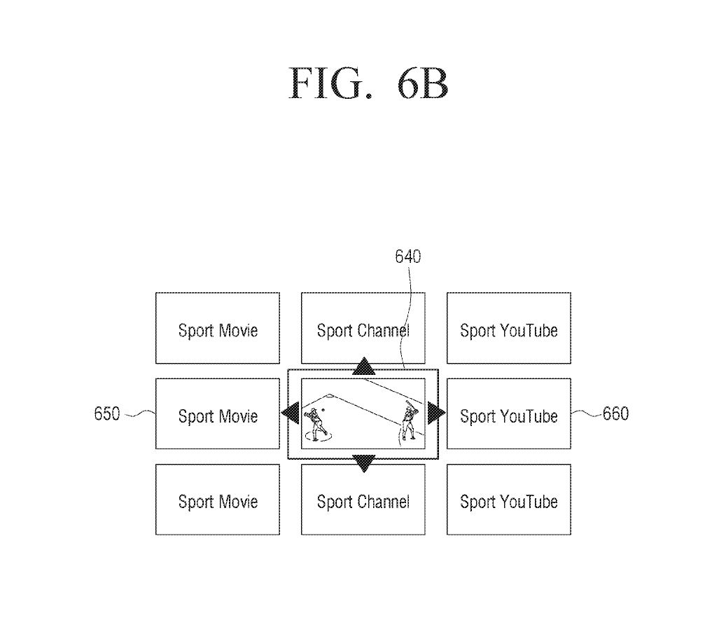

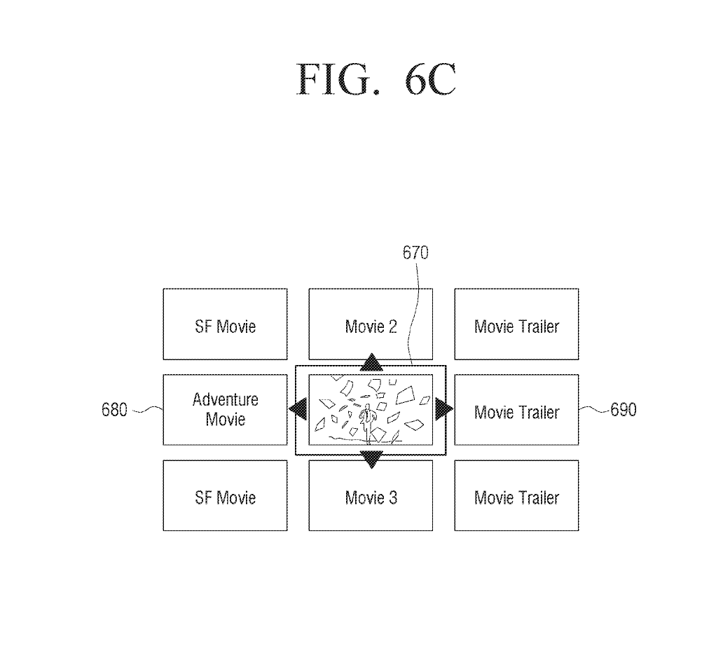

FIGS. 6A to 6C are views to illustrate change of virtual content arrangements according to various exemplary embodiments.

FIG. 6A is a view to illustrate change of virtual content arrangements with reference to content and a product displayed on the content according to an exemplary embodiment. Referring to FIG. 6A, in response to a first content which is being reproduced being changed to a second content, the processor 140 may change virtual content arrangements such that contents related to the second content are arranged in the proximity of the second content from among the contents belonging to each of the categories.

In particular, the processor 140 may determine related contents based on the type of the second content which is changed and reproduced, and a product displayed on the second content. For example, when the second content is the first episode 610 of a specific drama, contents subsequent to the second episode 630 of the specific drama may be determined as related contents in the VOD category on the right side. In addition, when a handbag is displayed on the second content, a shopping channel 620 related to the handbag may be determined as a related content in the life information category on the left side.

The processor 140 may change the virtual content arrangements such that the related contents are arranged in the proximity of the second content. For example, the processor 140 may determine all of the episodes of the specific drama as the related contents in the VOD category on the right side, and in particular, may change the arrangements such that the second episode 630 of the specific dram is located on the right side of the second content.

FIG. 6B is a view to illustrate change of virtual content arrangements with reference to details of content according to another exemplary embodiment. Referring to FIG. 6B, the processor 140 may determine related contents based on the details of the second content which is changed and reproduced. For example, when the second content is a broadcast of a baseball game 640, the highlight 660 of the baseball game may be determined as a related content in the YouTube category on the right side. In addition, a movie 650 related to the baseball may be determined as a related content in the movie category on the left side.

FIG. 6C is a view to illustrate change of virtual content arrangements with reference to the type of content according to another exemplary embodiment. Referring to FIG. 6C, the processor 140 may determine related contents based on the type of the second content which is changed and reproduced. For example, when the second content is a specific movie 670, the movie trailer, the making film 690, etc. of the specific movie may be determined as related contents in the movie trailer category on the right side. In addition, a movie 680 similar to the specific movie in genre may be determined as a related content in the movie category on the left side.

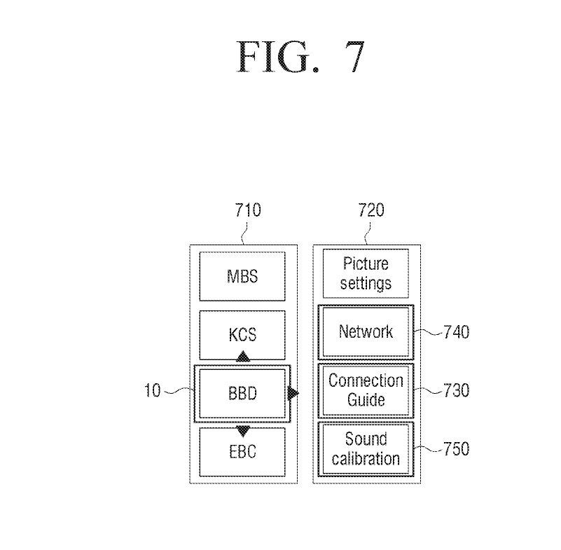

FIG. 7 is a view to illustrate change of arrangements of a setting category 720 according to an exemplary embodiment.

Referring to FIG. 7, the category includes the setting category 720 including at least one function for controlling the display apparatus 100, and, in response to a first content which is being reproduced being changed to a second content, the processor 140 may change the virtual content arrangements such that a frequently used function from among the functions belonging to the setting category 720 is arranged in the proximity of the second content.

For example, in response to content to be displayed being changed to a BBD broadcast while a KCS broadcast of a broadcast content category 710 is being displayed, the arrangements of the functions in the setting category 720 may also be changed. On the assumption that a connection guide function 730 is the most frequently used function, the connection guide function 730 may be located on the right side of the KCS broadcast on the virtual content arrangements before the content is changed by the user. After that, in response to the content being changed by the user, the processor 140 may move the connection guide function 730 to the right side of the BBD broadcast on the virtual content arrangements.

In FIG. 7, the functions of the setting category 720 are arranged based on the frequency of use. However, this should not be considered as limiting. For example, a function related to the displayed content may be arranged in the proximity of the content. When the displayed content is music broadcast content, a sound calibration function 750 may be arranged nearest to the content.

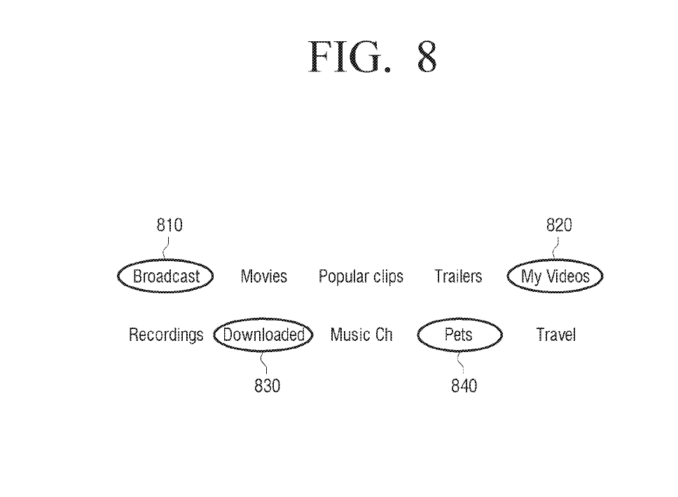

FIG. 8 is a view to illustrate generation of virtual content arrangements according to an exemplary embodiment.

Referring to FIG. 8, the processor 140 may display a UI screen providing information on a plurality of categories in order for the user to select a category of a first axis, and generate virtual content arrangements by arranging the categories selected according to a user input on the UI screen in sequence.

FIG. 8 illustrates a UI screen on the assumption that the UI screen provides category information such as Broadcast, Movies, Popular clips, etc. However, this should not be considered as limiting. A variety of category information may be additionally included.

In FIG. 8, it is assumed that the user selects the categories in the order of Broadcast category 810, My Videos category 820, Downloaded category 830, and Pets category 840. Accordingly, the processor 140 may generate the virtual content arrangements by arranging the Broadcast category 810, My Videos category 820, Downloaded category 830, and Pets category 840 from the left side in sequence.

The processor 140 may not include the categories which are not selected in the arrangements. However, this should not be considered as limiting. For example, the processor 140 may arrange the selected categories from the left side in sequence and then may additionally arrange the unselected categories.

FIG. 9 is a flowchart to illustrate a control method of a display apparatus 100 according to an exemplary embodiment.

Referring to FIG. 9, the display apparatus 100 receives a user command on first axis and second axis directions (S910). According to the user command, the display apparatus 100 navigates to find content on virtual content arrangements including a first axis along which contents are classified into categories, and a second axis along which the contents belonging to each of the categories are arranged (S920). In response to a second content being selected by the content navigation while a first content is being reproduced, the display apparatus 100 changes the first content which is being reproduced to the second content, and reproduce the second content (S930).

The control method may further include, in response to a predetermined user command being received while the first content is being reproduced, reducing an area on which the first content is reproduced, and displaying a plurality of contents arranged in the proximity of the first content on the virtual content arrangements on the other areas of a screen.

In addition, the control method may further include, in response to a predetermined user command being received while the first content is being reproduced, reducing the virtual content arrangements including the first content and displaying the virtual content arrangements in a form of a thumbnail list.

The displaying may include determining the number of contents included in the thumbnail list based on at least one of a resolution and a screen size of the display apparatus.

The control method may further include, in response to the first content which is being reproduced being changed to the second content, changing the virtual content arrangements such that contents related to the second content are arranged in the proximity of the second content from among the contents belonging to each of the categories.

The category may include a setting category including at least one function for controlling the display apparatus, and the control method may further include, in response to the first content which is being reproduced being changed to the second content, changing the virtual content arrangements such that a frequently used function is arranged in the proximity of the second content from among functions belonging to the setting category.

The category may include at least one of a broadcast content category, a web content category, a favorite category, and a setting category.

The control method may further include displaying a UI screen which provides information on a plurality of categories for selecting a category of the first axis along which the contents are classified into the categories, and generating the virtual content arrangements by arranging the categories selected according to a user input on the UI screen in sequence.

The navigating to find the content (S920) may include generating the virtual content arrangements by dividing the categories in a horizontal axis direction and arranging the plurality of contents belonging to each of the categories in a vertical axis direction, and navigating in the horizontal axis direction and the vertical axis direction according to a four-direction user command to find the content.

In addition, the receiving (S910) may include receiving the user command by means of one of a motion input, a pointing input, a voice input, a touch input, and a button input of a user.

According to the various exemplary embodiments as described above, the display apparatus can reproduce content which is selected by navigating on the arrangements according to a user command, and thus can provide users with convenience in manipulating.

The methods according to the various exemplary embodiments may be programmed and stored in various storage media. Accordingly, the methods according to the above-described various exemplary embodiments may be implemented in various kinds of electronic devices executing storage media.

Specifically, according to an exemplary embodiment, a non-transitory computer readable medium which stores a program for performing, in sequence, the operation of: receiving a user command on directions of a first axis and a second axis; according to the user command, navigating to find content on virtual content arrangements which include the first axis along which contents are classified into categories, and the second axis along which the contents belonging to each of the categories are arranged; and, in response to a second content being selected by the content navigation while a first content is being reproduced, changing the first content which is being reproduced to the second content and reproducing the second content.

The non-transitory computer readable medium refers to a medium that stores data semi-permanently rather than storing data for a very short time, such as a register, a cache, a memory or etc., and is readable by an apparatus. Specifically, the above-described various applications or programs may be stored in the non-transitory computer readable medium such as a compact disc (CD), a digital versatile disk (DVD), a hard disk, a Blu-ray disk, a universal serial bus (USB), a memory card, a ROM or etc., and may be provided

The foregoing exemplary embodiments and advantages are merely exemplary and are not to be construed as limiting the embodiments. The present teaching can be readily applied to other types of apparatuses. Also, the description of the exemplary embodiments is intended to be illustrative, and not to limit the scope of the claims, and many alternatives, modifications, and variations will be apparent to those skilled in the art.

Although a few embodiments have been shown and described, it would be appreciated by those skilled in the art that changes may be made in these embodiments without departing from the principles and spirit of the embodiments, the scope of which is defined in the claims and their equivalents.

1. A display apparatus, comprising:
a display;
a storage configured to store virtual content arrangements which comprise a first axis along which contents are classified into categories, and a second axis along which the contents belonging to each of the categories are arranged;
a user interface configured to receive a user direction command on directions of the first axis and the second axis; and
a processor configured to navigate to find content of the virtual content arrangements according to the user command, and, in response to a second content being selected by content navigation while a first content is being reproduced, control the display to change the first content which is being reproduced to the second content and reproduce the second content.

2. The display apparatus of claim 1, wherein, in response to a predetermined user command being received while the first content is being reproduced, the processor is configured to reduce an area on which the first content is reproduced, and control to display a plurality of contents arranged in proximity of the first content on the virtual content arrangements on other areas of a screen.

3. The display apparatus of claim 1, wherein, in response to a predetermined user command being received while the first content is being reproduced, the processor is configured to reduce the virtual content arrangements comprising the first content and display the virtual content arrangements in a form of a thumbnail list.

4. The display apparatus of claim 3, wherein the processor is configured to determine a number of contents included in the thumbnail list based on at least one of a resolution and a screen size of the display.

5. The display apparatus of claim 1, wherein, in response to the first content which is being reproduced being changed to the second content, the processor is configured to change the virtual content arrangements such that contents related to the second content are arranged in proximity of the second content from among the contents belonging to each of the categories.

6. The display apparatus of claim 1, wherein the categories comprise a setting category comprising at least one function for controlling the display apparatus, and
wherein, in response to the first content which is being reproduced being changed to the second content, the processor is configured to change the virtual content arrangements such that a frequently used function is arranged in proximity of the second content from among functions belonging to the setting category.

7. The display apparatus of claim 1, wherein the categories comprise at least one of a broadcast content category, a web content category, a favorite category, and a setting category.

8. The display apparatus of claim 1, wherein the processor is configured to display a UI (user interface) screen which provides information on a plurality of categories for selecting a category of the first axis along which the contents are classified into the categories, and generate the virtual content arrangements by arranging the categories selected according to a user input on the UI screen in sequence.

9. The display apparatus of claim 1, wherein the processor is configured to generate the virtual content arrangements by dividing the categories in a horizontal axis direction and arranging the plurality of contents belonging to each of the categories in a vertical axis direction, and to navigate in the horizontal axis direction and the vertical axis direction according to a four-direction user command to find content.

10. The display apparatus of claim 1, wherein the user interface is configured to receive the user direction command by means of one of a motion input, a pointing input, a voice input, a touch input, and a button input of a user.

11. A control method of a display apparatus, comprising:
receiving a user direction command on directions of a first axis and a second axis;
according to the user direction command, navigating to find content on virtual content arrangements which comprise the first axis along which contents are classified into categories, and the second axis along which the contents belonging to each of the categories are arranged; and
in response to a second content being selected by content navigation while a first content is being reproduced, changing the first content which is being reproduced to the second content and reproducing the second content.

12. The control method of claim 11, further comprising, in response to a predetermined user command being received while the first content is being reproduced, reducing an area on which the first content is reproduced, and displaying a plurality of contents arranged in proximity of the first content on the virtual content arrangements on other areas of a screen.

13. The control method of claim 11, further comprising, in response to a predetermined user command being received while the first content is being reproduced, reducing the virtual content arrangements comprising the first content and displaying the virtual content arrangements in a form of a thumbnail list.

14. The control method of claim 13, wherein the displaying comprises determining a number of contents included in the thumbnail list based on at least one of a resolution and a screen size of the display apparatus.

15. The control method of claim 11, further comprising, in response to the first content which is being reproduced being changed to the second content, changing the virtual content arrangements such that contents related to the second content are arranged in proximity of the second content from among the contents belonging to each of the categories.

16. The control method of claim 11, wherein the categories comprise a setting category comprising at least one function for controlling the display apparatus, and
wherein the control method further comprises, in response to the first content which is being reproduced being changed to the second content, changing the virtual content arrangements such that a frequently used function is arranged in proximity of the second content from among functions belonging to the setting category.

17. The control method of claim 11, wherein the categories comprise at least one of a broadcast content category, a web content category, a favorite category, and a setting category.

18. The control method of claim 11, further comprising displaying a UI (user interface) screen which provides information on a plurality of categories for selecting a category of the first axis along which the contents are classified into the categories, and generating the virtual content arrangements by arranging the categories selected according to a user input on the UI screen in sequence.

19. The control method of claim 11, wherein the navigating to find the content comprises generating the virtual content arrangements by dividing the categories in a horizontal axis direction and arranging the plurality of contents belonging to each of the categories in a vertical axis direction, and navigating in the horizontal axis direction and the vertical axis direction according to a four-direction user command to find the content.

20. (canceled)

21. A control method, comprising:
virtually arranging different content along a first axis and versions of the different content along a second axis
displaying a first content among the different content;
allowing a user to directionally select a second content by a directional command directing movement along one of the axes; and
displaying the second content.
